(19) United States
(12) Patent Application Publication
(10) Pub. No.: US 2005/0265011 A1
(43) Pub. Date: Dec. 1, 2005

(54) Grounding spring for removable tuner module

(76) Inventors: Daniel F. McMiller, Cardiff By The Sea, CA (US); William R. Doyle, San Diego, CA (US); Dinh C. Phan, San Diego, CA (US); Chris Rubis, San Diego, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/853,317

(22) Filed: May 25, 2004

(51) Int. Cl. H01R 4/66

(52) U.S. Cl. 361/815

(57) ABSTRACT

A conductive ground spring includes a body, an extrusion coupled to the body, a grounding flange disposed on an end of the extrusion opposite of the body, and an orifice disposed in the body, wherein the orifice is configured to receive a tuner connector.

### FIELD

The present system and method relate to cable tuners. More particularly, the present system and method provides a grounding spring that may be coupled to a removable tuner module.

### BACKGROUND

The television (TV) has become ubiquitous in modem society. As a result, a variety of services are being provided via TV. Many of these services are provided using a consumer premise component such as a set-top box that works in conjunction with the TV to provide the desired service. These consumer premise components enable standard television sets to receive video and/or audio signals transmitted over cable or satellite networks.

In conjunction with providing desired audiovisual services to consumers, consumer premise components also aid in maintaining a secure connection between the consumer and a transmitting entity by providing a descrambler or decoder unit, which unscrambles or decodes a signal carrying the desired programming. Unauthorized parties who do not have the consumer premise component will be unable to receive the audiovisual programming in an intelligible form.

However, the elements of the consumer premise components may readily become obsolete for a variety of reasons such as changing methods of encoding or the addition of new features and functions. Traditionally, the above-mentioned situations were remedied by providing authorized subscribers with a new consumer premise component containing an updated tuner/decoder unit designed to fully receive and translate the signals transmitted by the signal provider. However, this solution is both expensive and time consuming, especially if authorized subscribers are widely spread over a large geographic region.

Alternatively, recent methods for solving the obsolescence of the elements of the consumer premise component have included manufacturing the consumer premise components to accept upgrade modules. While this method often eliminates the need for providing consumers with updated decoders, the installation and manufacture of these traditionally metal modules has proven to be somewhat cost prohibitive.

### SUMMARY

A conductive ground spring includes a body, an extrusion coupled to the body, a grounding flange disposed on an end of the extrusion opposite the body, and an orifice disposed in the body, wherein the orifice is configured to receive a tuner connector.

According to a second embodiment, a radio frequency (RF) tuner module includes a non-conductive housing, a tuner module disposed in the non-conductive housing, a tuner connector communicatively coupled to the tuner module, the connector extruding from the non-conductive housing, and a grounding spring disposed on the connector, wherein the grounding spring includes a body, an extrusion coupled to the body, a grounding flange disposed on an end of the extrusion opposite the body, and an orifice disposed in the body, the orifice being configured to receive the tuner connector.

### BRIEF DESCRIPTION OF THE DRAWINGS

The accompanying drawings illustrate various embodiments of the present system and method and are a part of the specification. Together with the following description, the drawings demonstrate and explain the principles of the present system and method. The illustrated embodiments are merely examples of the present system and method and in no way limit the scope there of.

FIG. 1 is a simple block diagram illustrating a satellite television network with a tree-and-branch architecture, according to one exemplary embodiment.

FIG. 2 is a simple block diagram illustrating the components of a traditional integrated receiver decoder, according to one exemplary embodiment.

FIG. 3 is a perspective view of an upgradeable consumer premise component and upgrade module, according to one exemplary embodiment.

FIG. 4 is an exploded view of an upgrade module, according to one exemplary embodiment.

FIG. 5 is a semi-assembled view illustrating an upgrade module, according to one exemplary embodiment.

FIG. 6 is a side view of a grounding spring, according to one exemplary embodiment.

FIG. 7 is a top view of a grounding spring, according to one exemplary embodiment.

FIG. 8 is a side view of a grounding spring, according to one exemplary embodiment.

FIG. 9 is an assembled view of an upgrade consumer premise component module, according to one exemplary embodiment.

FIG. 10 is a side view of an assembled upgrade consumer premise component module, according to one exemplary embodiment.

FIG. 11 is a flow chart illustrating a method for assembling the upgrade consumer premise component, according to one exemplary embodiment.

FIG. 12 is a perspective view illustrating the insertion of an upgrade module into a consumer premise component, according to one exemplary embodiment.

FIG. 13 is a perspective view illustrating an upgrade module inserted into a consumer premise component, according to one exemplary embodiment.

Throughout the drawings, identical reference numbers designate similar, but not necessarily identical, elements.

### DETAILED DESCRIPTION

The present specification describes a number of exemplary methods and systems for forming and using a grounding spring for a removable consumer premise component module. More specifically, the present system and method provide a grounding spring that may be coupled to an F-connector of an upgrade module, thereby allowing the housing portion of the upgrade module to be made out of an easily manufactured, non-conductive material such as plastic. A number of exemplary geometries, materials, and applications of the present grounding spring are described in detail below.

As used in the present specification and in the appended claims, the term “consumer premise component” or “CPC” is meant to be understood broadly as including any set-top box, satellite receivers, lightweight modular display system (LMDS), multimedia display system (MMDS), or any IRD (integrated receiver/decoder). Additionally, “audiovisual programming” or “audiovisual signal” includes video and audio signals, whether transmitted alone or in combination as well as data, games (or other programs), graphics, control, telephony, text or other information independent of format.

A “set-top box” or “STB” is meant to be understood broadly as any electrical component that is configured to be located at a consumer location, receive a signal from a signal transmission source such as a satellite head-end unit, a cable head-end unit, or a terrestrial signal from a local broadcast and process data associated with the received signal. One example of a set-top box is an “integrated receiver decoder” or

In the following description, for purposes of explanation, numerous specific details are set forth in order to provide a thorough understanding of the present system and method for forming a grounding spring for a removable consumer premise component module. It will be apparent, however, to one skilled in the art that the present method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

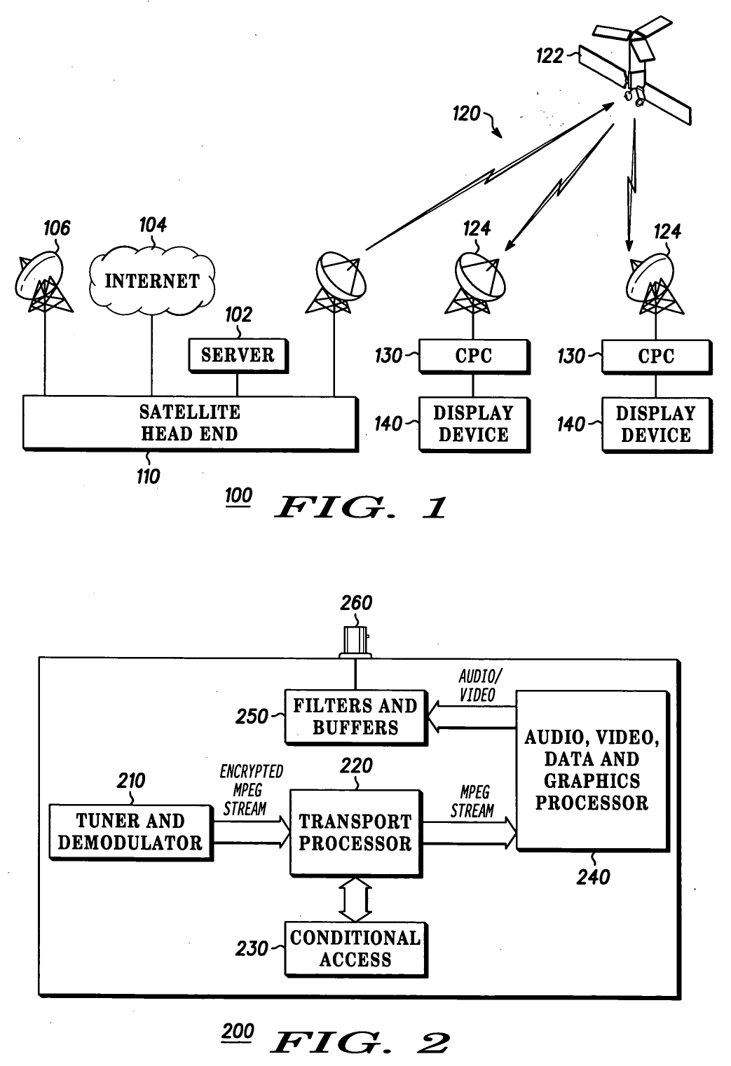

Referring now to the drawings, FIG. 1 illustrates a satellite television network (100) with a tree-and-branch architecture according to one exemplary embodiment. As shown in FIG. 1, the satellite television network (100) includes a satellite headend unit (110). As shown in FIG. 1, a number of data sources (102, 104, 106) may be communicatively coupled to the satellite headend unit (110) including, but in no way limited to, a plurality of servers (102), the Internet (104), radio signals, or television signals received via a satellite connection (106). The satellite headend (110) is also communicatively coupled to one or more consumer premise components (130) through a satellite broadcast network (120). The consumer premise component (130) may then be coupled to a display device (140).

As shown in FIG. 1, the satellite headend (110) is coupled to a number of data sources (102, 104, 106). The satellite headend (110) illustrated in the exemplary embodiment shown in FIG. 1 may be any centralized facility or a system at a satellite TV office that originates and communicates satellite TV services and/or satellite modem services to subscribers. The satellite TV services and/or satellite modem services may be received by the satellite headend (110) from any number of sources including those listed above. Once received in the satellite headend (110), the TV services and/or satellite modem services are encoded to eliminate redundant or irrelevant data, and information is extrapolated to reduce the overall size of the files providing the services. The TV services and/or satellite modem services are also encrypted prior to transmission to prevent unauthorized access to the signals.

The satellite broadcast network (120) illustrated in FIG. 1 is the medium over which the RF signals produced by the satellite headend unit (110) or by a CPC (130) are transmitted. The satellite broadcast network (120) may be any medium configured to transmit RF signals including, but in no way limited to, a satellite (122) to dish (124) network, a coaxial cable network, a fiber optic cable network, or a hybrid cable network.

Once transmitted through the satellite broadcast network (120), a downstream signal is received by a designated consumer premise component (CPC) (130). FIG. 2 illustrates the internal components of a CPC (130) according to one exemplary embodiment. As shown in FIG. 2, a CPC in the form of an integrated receiver decoder (IRD) (200) includes a tuner and demodulator (210) communicatively coupled to a transport processor (220). The transport processor (220) is in turn communicatively coupled to a media access control unit (conditional access device) (230) and an audio, video, data, and graphics processor (240). The audio, video, data, and graphics processor (240) is then coupled to a number of filters and buffers (250) which lead to a signal out connection (260) that may then be communicatively coupled to an external display device (140; FIG. 1).

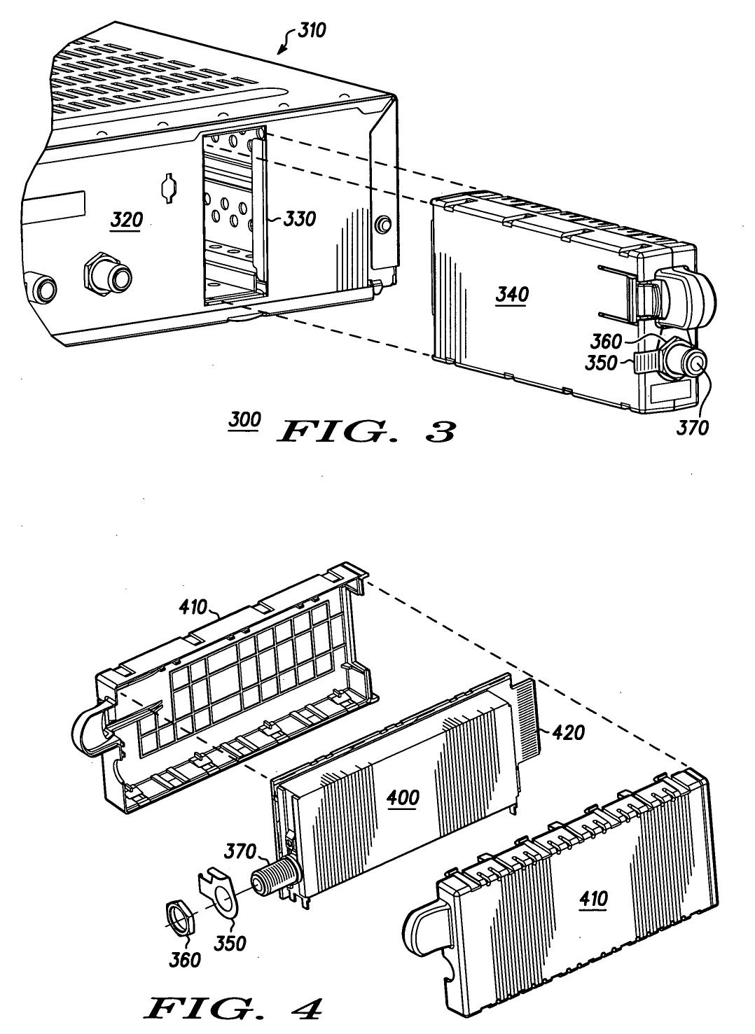

As noted above, the internal components of the CPC (130; FIG. 1) such as the tuner and demodulator (210) may become outdated or useless due to any number of conditions. Consequently, an upgradeable consumer premise component such as that illustrated in FIG. 3 has been developed. As illustrated in FIG. 3, the upgradeable consumer premise component (300) includes a CPC chassis (310) having a grounded surface (320) and a module port (330) disposed within the grounded surface. Additionally, a removable upgrade module (340) is included in FIG. 3. Traditionally, the removable upgrade modules (340) associated with upgradeable consumer premise components included a casing made out of a metal or another conductive material. Consequently, when the traditional conductive housing is inserted into the module port, a ground is established though contact between the conductive housing and the grounded surface (320). However, manufacture of the conductive casings is both temporally and resourcefully expensive.

Consequently, as illustrated in FIG. 3, the present system and method includes a grounding spring (350) coupled to the F-connector (370) of the removable module (340) by a fastener (360). The inclusion of the grounding spring (350) provides a ground to the circuitry included within the removable upgrade module (340), allowing the module housing to be constructed out of a non-conductive material such as plastic. According to this exemplary embodiment, manufacture of the module housing using plastic allows for less expensive and rapid manufacture through such forming methods as injection molding.

FIG. 4 is an exploded view, illustrating the components of a removable upgrade module, according to the present system and method. As illustrated in FIG. 4, the upgrade module includes a non conductive module housing (410) that surrounds an upgrade tuner module (400) having an F-connector (370) and a processor interface (420). According to one exemplary embodiment, the upgrade tuner module (400) is a vestigial side band (VSB)/phase shift keying (PSK) tuner module. Alternatively, the upgrade tuner module may be configured to decode any number of coded signals such as coded orthogonal frequency division multiplexing (COFDM) signals. As mentioned above, when the processor interface (420) is inserted into the module port (330; FIG. 3) and communicatively coupled to the transport processor (220; FIG. 2) of the consumer premise component, the upgrade tuner module (400) may receive a coded audiovisual signal and demodulate that signal into a signal acceptable by the upgradeable consumer premise component (300; FIG. 3). According to one exemplary embodiment, the circuitry of the upgrade tuner module (400) receives power through the processor interface (420). However, a ground connection cannot be established through the non-conductive module housing (410) because it is constructed from a non-conductive material. In order to provide the vital ground connection, a grounding spring (350) configured to be coupled to the F-connector (370) is provided. While the present exemplary embodiment is illustrated in the context of a grounding spring (350) coupled to an F-connector, which is a common coaxial connector used for video applications, any connector used to receive data signals from a network may be used including, but in no way limited to, an s-video connector, a fiber-optic cable connector, or an RCA connector. As illustrated in FIG. 4, the grounding spring (350) may be coupled to the F-connector (370) by a fastener (360) such as a nut.

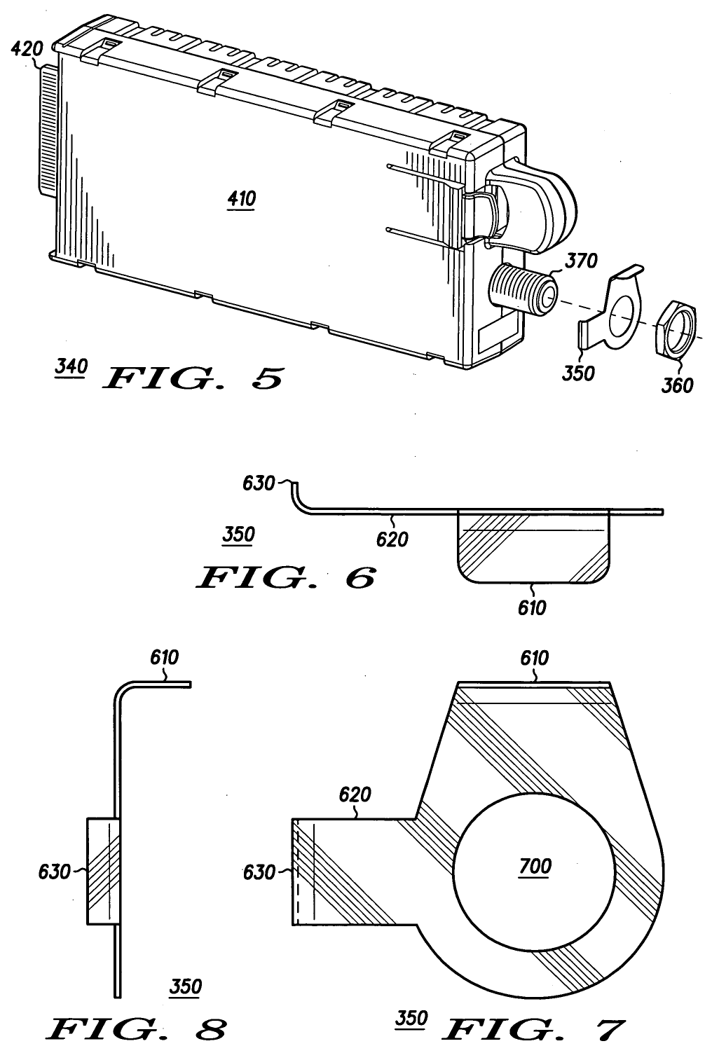

FIG. 5 further illustrates a partially assembled removable upgrade module (340) according to one exemplary embodiment. As illustrated in FIG. 5, when the non-conductive module housing (410) is coupled around the upgrade tuner module (400; FIG. 4), the F-connector (370) and the processor interface (420) portions of the upgrade tuner module are exposed. This configuration allows the processor interface (420) to be communicatively coupled to a transport processor (220; FIG. 2), and allows the F-connector (370) to externally receive the grounding spring (350) and the fastener (360).

FIGS. 6, 7, and 8 further illustrate the grounding spring, according to one exemplary embodiment. FIG. 6 illustrates a planar side view of the grounding spring, according to one exemplary embodiment. As shown in FIG. 6, the grounding spring (350) is formed from a relatively thin, yet conductive material, such as a metal. The thickness of the conductive material used to form the grounding spring (350) is such that a grounding flange (630), shown in FIG. 6, may contact a grounded surface causing a flexure of the spring extrusion (620). Allowing some flexure of the spring extrusion (620) will permit the processor interface (420; FIG. 4) to be variably seated in the module port (330; FIG. 3) while maintaining the ground connection. Additionally, the relatively thin cross-section of the material used to form the exemplary grounding spring (350) allows the grounding spring to be formed using inexpensive forming methods such as stamping. As illustrated in FIG. 6, the grounding spring (350) also includes a stability flange (610), according to one exemplary embodiment. According to the exemplary embodiment, the stability flange (610) is configured to abut an extruding surface of the non-conductive module housing (410; FIG. 5), thereby preventing a rotation of the grounding spring (350) after installation.

FIG. 7 illustrates a top view of the grounding spring (350) further illustrating the components thereof. As illustrated in FIG. 7, the grounding spring (350) includes a main body portion (710) having a connector receiving orifice (700) formed therein. According to one exemplary embodiment, the connector receiving orifice (700) is configured to receive an F-connector. FIG. 7 also illustrates the spring extrusion (620) extending from the main body (710) and terminating with the grounding flange (630).

FIG. 8 further illustrates the respective orientation of the stability flange (610) and the grounding flange (630). According to the exemplary embodiment illustrated in FIG. 8, the stability flange (610) and the grounding flange (630) are disposed in divergent planes.

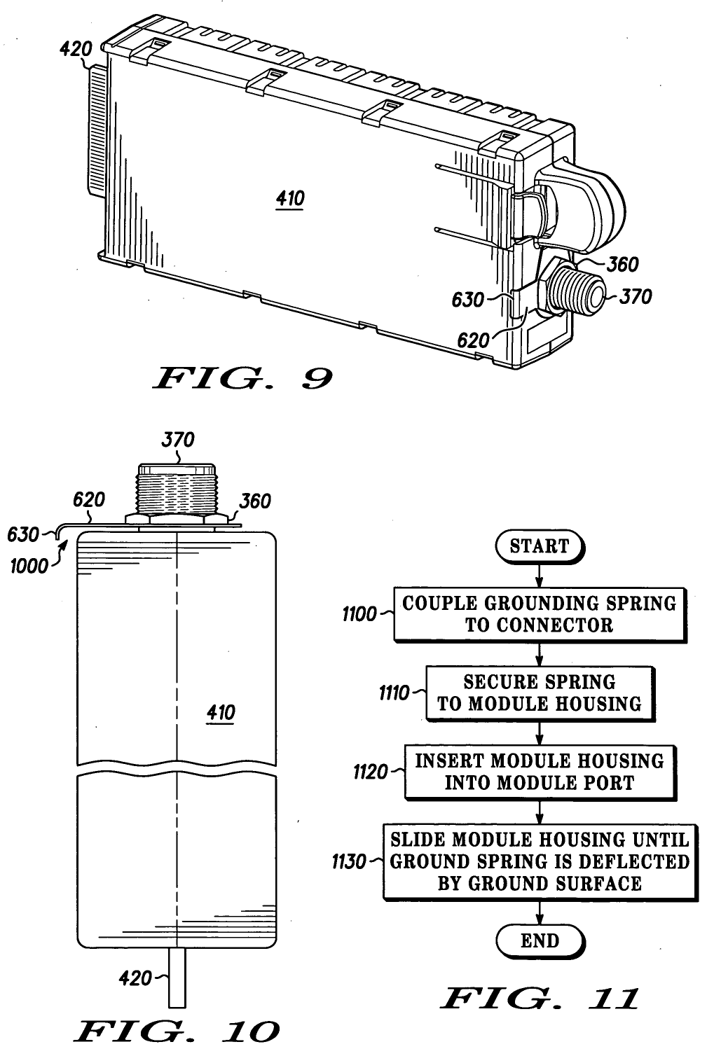

As illustrated in the assembled view shown in FIG. 9, the spring extrusion (620) is sufficiently long to cause the grounding flange to extend past the top edge of the non-conductive module housing (410). FIG. 9 also illustrates the stability flange (610) disposed adjacent to a housing extrusion (900) such as a grip. The position of the stability flange (610) with respect to the housing extrusion (900) causes an interference with a rotation of the grounding spring.

FIG. 10 is a side view further illustrating the extension of the spring extrusion (620) with respect to the non-conductive module housing (410). As illustrated in FIG. 10, the grounding spring is secured to the F-connector (370) by a fastener (360). According to one exemplary embodiment, the fastener (360) is a nut that is threaded onto the threads of the F-connector (370). Once fastened, the relative distance between the connector receiving orifice (700; FIG. 7) and the grounding flange (630), as represented by the spring extrusion (620), is sufficient to position the grounding flange adjacent to the side surface of the non-conductive module housing (410). As illustrated in FIG. 10, according to one exemplary embodiment, the grounding flange may be positioned such that a contact gap (1000) is present between the grounding flange (630) and the non-conductive module housing (410). This contact gap (1000) allows for the insertion of the non-conductive module housing (410) into a module port (330; FIG. 3) while establishing a ground contact to the F-connector as will be further discussed in detail below.

Exemplary Implementation and Operation

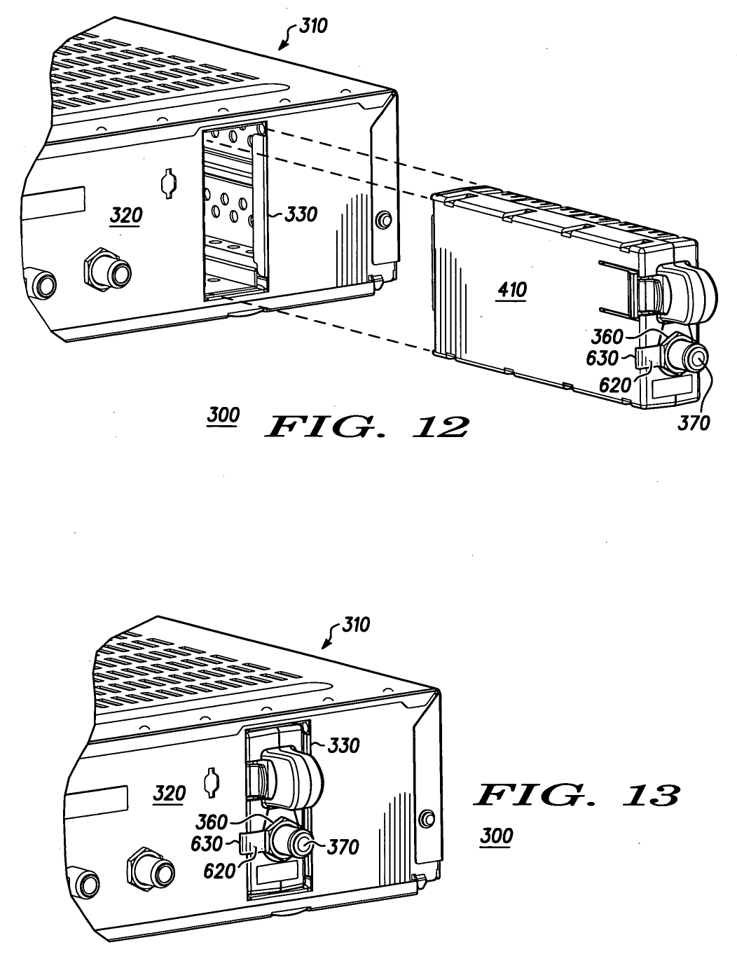

FIG. 11 illustrates a method for establishing a ground connection on an F-connector portion of a removable tuner module encased in a non-conductive material, such that the module can be easily removed by a consumer. As illustrated in FIG. 11, the present method begins by coupling the grounding spring to the F-connector (step 1100). Once coupled to the F-connector, the grounding spring is secured to the module housing (step 1110). When the grounding spring is both coupled and secured, the module is inserted into the module port (step 1120). The module is slid inside the module port until contact is made, causing a deflection of the grounding spring on the grounded surface (step 1130), thereby establishing a ground for the F-connector. The above-mentioned steps will now be described in further detail below with reference to FIGS. 12 and 13.

As illustrated in FIG. 11, the present method begins by coupling the grounding spring to the F-connector. As shown in FIG. 12, the ground spring may be coupled to the F-connector (370) by sliding the connector receiving orifice (700; FIG. 7) over the F-connector. During the coupling of the ground spring to the F-connector (370), the ground spring may be rotated to appropriately position the grounding flange (630) and/or the stability flange (610). Placement of the ground spring over the F-connector may be performed either during manufacture of the removable upgrade module or at a consumer location by the consumer.

Once the grounding spring (350; FIG. 3) is coupled to the F-connector (370), the spring may be secured to the non-conductive module housing (step 1110; FIG. 11) with a nut or other fastener (360). According to one exemplary embodiment, the nut or other fastener (360) prevents an ascendant translation of the grounding spring (350; FIG. 3), thereby aiding in preventing any subsequent rotation of the grounding spring.

With the grounding spring securely coupled to both the F-connector (370) and the non-conductive module housing (410), the removable module (340; FIG. 3) may be inserted into the module port (step 1120). According to one exemplary embodiment illustrated in FIG. 12, the module port (330) is configured to accept the removable module (340; FIG. 3) without permitting lateral movement of the removable module. That is, a number of guides or other structural elements may be included in the module port (330) to assure the processor interface (420; FIG. 4) of the removable module (340; FIG. 3) is translated directly to an interface receiving port (not shown) that is communicatively coupled to the transport processor (220; FIG. 2). According to this exemplary embodiment, the removable module (340; FIG. 3) may be easily inserted into the module port (330) by a consumer without the aid of tools.

The removable module (340; FIG. 3) is slid inside the module port (330) until contact is made between the grounding spring and the grounded surface. This contact causes a deflection of the grounding spring on the grounded surface (step 1130; FIG. 11), thereby establishing a ground for the F-connector (370). FIG. 13 further illustrates a removable module (340; FIG. 3) that has been inserted into the module port (330; FIG. 12) until a deflection of the grounding spring occurs. As illustrated in FIG. 13, as the removable module (340; FIG. 3) is inserted, the grounding flange (630) that overhangs the side of the non-conductive module housing (410; FIG. 12) will not be inserted into the module port (330; FIG. 12). Rather, according to this exemplary embodiment, the spring extrusion (620) extends the grounding flange (630) past the edge of the module port and onto the grounded surface (320) forming a part of the CPC chassis (310; FIG. 3). According to this exemplary embodiment, as the removable module (340; FIG. 3) is inserted sufficiently to couple the processor interface (420; FIG. 4) into an interface receiving port (not shown), the grounding flange (630) makes contact with the grounded surface (320) and causes a deflection of the spring extrusion (620). As the removable module (340; FIG. 3) is locked into its final position by any number of securing mechanisms (not shown), the spring extrusion (620) remains deflected. This constant deflection of the spring extrusion (620) exerts a force on the grounding flange (630) towards the grounded surface (320), assuring continual contact between the grounding flange and grounded surface while the removable module (340; FIG. 3) is inserted, without the use of fasteners or hardware to be installed by the consumer.

Alternative Embodiments

According to one alternative embodiment, the length of the spring extrusion (620) illustrated in FIG. 12 may be sufficient to extend the grounding flange (630) to the edge of the non-conductive module housing (410), but not sufficiently past the non-conductive module housing (410) to prevent insertion with the module port (330). Rather, according to this exemplary embodiment, the grounding flange (630) may be allowed to enter the module port and contact a grounded portion of the CPC chassis (310) disposed inside the module port. According to this exemplary embodiment, the length and/or shape of the grounding flange (630) may vary in order to facilitate the above-mentioned contact.

In conclusion, the present system and method for a grounding spring for a removable consumer premise component module allows the housing of the removable consumer premise component module to be manufactured from a non-conductive material. Additionally, the present grounding spring allows the removable module to be easily installed and/or removed by a consumer without the need for tools. Moreover, the ground contact established by the present grounding spring is well established without the use of hardware or fasteners.

The preceding description has been presented only to illustrate and describe the present system and method. It is not intended to be exhaustive or to limit the present system and method to any precise form disclosed. Many modifications and variations are possible in light of the above teachings.

The foregoing embodiments were chosen and described in order to illustrate principles of the system and method as well as some practical applications. The preceding description enables others skilled in the art to utilize the system and method in various embodiments and with various modifications as are suited to the particular use contemplated. It is intended that the scope of the system and method be defined by the following claims.

1. A conductive ground spring comprising:
a body;
an extrusion coupled to said body;
a grounding flange disposed on an end of said extrusion, said end being disposed opposite of said body; and
an orifice disposed in said body, wherein said orifice is configured to receive a tuner connector.

2. The ground spring of claim 1, wherein said conductive ground spring comprises a metal.

3. The ground spring of claim 1, wherein said extrusion is configured to extend said grounding flange to an edge of a tuner module housing when said orifice is coupled to said tuner connector.

4. The ground spring of claim 3, wherein said extrusion is configured to extend said grounding flange sufficiently past said edge of said tuner module housing such that when said tuner module housing is inserted into a module port of a consumer premise device, said grounding flange contacts a grounding surface of said consumer premise device.

5. The ground spring of claim 4, wherein said extrusion is configured to flex when said grounding flange contacts said grounding surface.

6. The grounding spring of claim 3, wherein said extrusion is configured to extend said ground flange past said edge of said tuner module housing such that said ground flange is received within a module port of a consumer premise device when said tuner module housing is inserted into said module port.

7. The grounding spring of claim 6, wherein said extrusion is configured to couple said ground flange to a grounded surface disposed within said module port.

8. The grounding spring of claim 1, further comprising:
a stability flange disposed on said body;
wherein said stability flange is configured to abut an extrusion of a tuner module housing when said orifice is coupled to said tuner connector.

9. The grounding spring of claim 8, wherein:
said stability flange is disposed in a first plane;
said grounding flange is disposed in a second plane; and
wherein said first plane and said second plane comprise divergent planes.

10. A radio frequency (RF) tuner module comprising:
a non-conductive housing;
a tuner module disposed in said non-conductive housing;
a tuner connector communicatively coupled to said tuner module, said connector extruding from said non-conductive housing; and
a conductive grounding spring disposed on said connector, wherein said grounding spring includes a body, an extrusion coupled to said body, a grounding flange disposed on an end of said extrusion opposite said body, and an orifice disposed in said body, said orifice being configured to receive said tuner connector.

11. The RF tuner module of claim 10, wherein said conductive ground spring comprises a metal.

12. The RF tuner module of claim 10, wherein said tuner connector comprises one of an F-connector, an s-video connector, a fiber-optic cable connector, or an RCA connector.

13. The RF tuner module of claim 10, wherein said extrusion is configured to extend said grounding flange to an edge of said non-conductive housing when said orifice is coupled to said tuner connector.

14. The RF tuner module of claim 13, wherein said extrusion is configured to extend said grounding flange sufficiently past said edge of said non-conductive housing such that when said RF tuner module housing is inserted into a module port of a consumer premise device, said grounding flange contacts a grounding surface of said consumer premise device.

15. The RF tuner module of claim 14, wherein said extrusion is configured to flex when said grounding flange contacts said grounding surface.

16. The RF tuner module of claim 13, wherein said extrusion is configured to extend said ground flange past said edge of said non-conductive housing such that said ground flange is received within a module port of a consumer premise device when said tuner module housing is inserted into said module port.

17. The RF tuner module of claim 16, wherein said extrusion is configured to couple said ground flange to a grounded surface disposed within said module port.

18. The RF tuner module of claim 10, wherein said tuner module comprises one of a vestigial side band (VSB) tuner module, a phase shift keying (PSK) tuner module, or a coded orthogonal frequency division multiplexing (COFDM) tuner module.

19. The RF tuner module of claim 10, wherein said conductive grounding spring further comprises:
a stability flange disposed on said body;
wherein said stability flange is configured to abut an extrusion of non-conductive housing when said orifice is coupled to said tuner connector.

20. A consumer premise component comprising:
an upgrade module port;
a grounded plane forming an outer portion of said upgrade module port; and
an upgrade module disposed in said port, wherein said upgrade module includes a non-conductive housing, a tuner module disposed in said non-conductive housing, a tuner connector communicatively coupled to said tuner module, said connector extruding from said non-conductive housing, and a conductive grounding spring disposed on said connector, wherein said conductive grounding spring includes a body, an extrusion coupled to said body, a grounding flange disposed on an end of said extrusion opposite of said body, and an orifice disposed in said body, said orifice being configured to receive said tuner connector.

21. The consumer premise component of claim 20, wherein said conductive ground spring comprises a metal.

22. The consumer premise component of claim 20, wherein said tuner connector comprises one of an F-connector, an s-video connector, a fiber-optic cable connector, or an RCA connector.

23. The consumer premise component of claim 20, wherein said extrusion is configured to extend said grounding flange to an edge of said non-conductive housing when said orifice is coupled to said tuner connector.

24. The consumer premise component of claim 23, wherein said extrusion is configured to extend said grounding flange sufficiently past an edge of said non-conductive housing such that when said RF tuner module housing is inserted into said module port, said grounding flange contacts said grounded plane.

25. The consumer premise component of claim 24, wherein said extrusion is configured to flex when said RF tuner module housing is fully inserted into said module port.

26. The consumer premise component of claim 23, wherein said extrusion is configured to extend said ground flange past said edge of said non-conductive housing such that said ground flange is received within said module port.

27. The consumer premise component of claim 26, wherein said extrusion is configured to couple said ground flange to a grounded surface disposed within said module port.
